(19) United States
(12) Patent Application Publication
(10) Pub. No.: US 2023/0386260 A1
(43) Pub. Date: Nov. 30, 2023

(54) DETECTING SPOOF IMAGES USING PATTERNED LIGHT

(71) Applicant: Microsoft Technology Licensing, LLC, Redmond, WA (US)

(72) Inventors: Neil EMERTON, Redmond, WA (US); Timothy Andrew LARGE, Southwater (GB)

(73) Assignee: Microsoft Technology Licensing, LLC, Redmond, WA (US)

(21) Appl. No.: 17/804,293

(22) Filed: May 26, 2022

(51) Int. Cl. G06V 40/40; G06V 10/145; G06V 40/16

(52) U.S. Cl. CPC G06V 40/40; G06V 10/145; G06V 40/172

(57) ABSTRACT

Examples are disclosed herein that relate to determining whether an imaged subject is real or spoofed. One example provides a computing system, comprising, a camera, a light pattern source configured to output a light pattern, a logic subsystem, a storage subsystem storing instructions executable by the logic subsystem to capture, via the camera, an image of a subject illuminated by the light pattern emitted by the light pattern source, determine, based at least upon a contrast of the light pattern in the image, whether the subject is real or a spoof, based at least upon determining that the subject is real, perform an action on the computing system, and based at least up on determining that the subject is a spoof, not perform the action on the computing system.

### BACKGROUND

Computing systems may utilize a camera to image a person for authentication, for example via facial or palm recognition. However, spoofing to gain unauthorized access may be accomplished by placing an image of a person in front of the camera to simulate their biometrics, thus gaining unauthorized access to a protected computing resource.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to determining whether an imaged subject is real or spoofed. One example provides a computing system comprising a camera, a light pattern source configured to output a light pattern, a logic subsystem, and a storage subsystem. The storage subsystem comprises instructions executable by the logic subsystem to capture, via the camera, an image of a subject illuminated by the light pattern, and determine, based at least upon a contrast of the light pattern in the image, whether the subject is real or a spoof. The instructions are further executable to, based at least upon determining that the subject is real, perform an action on the computing system, and based at least up on determining that the subject is the spoof, not perform the action on the computing system.

### BRIEF DESCRIPTION OF THE DRAWINGS

FIG. 1 shows an example use scenario in which a computing system images a subject to determine whether the subject is real or spoofed.

FIG. 2 shows an example computing system configured to determine whether an imaged subject is real or spoofed by acquiring an image of the subject as illuminated by a light pattern.

FIG. 3 shows an example image of a portion of a real face illuminated by a light pattern comprising a laser speckle pattern.

FIG. 4 shows an example image of a piece of paper on which the face of FIG. 3 is printed, and that is illuminated by the light pattern of FIG. 3.

FIG. 5 shows an example image of a white board material backed by aluminum, illuminated by the light pattern of FIG. 3.

FIG. 6 shows a plot of example data showing speckle contrast versus correlation length for a white board material and a real face for two different patterns of light.

FIG. 7 shows a plot of an example effective modulation transfer function (MTF) of human skin versus spatial frequency of light patterns projected onto human skin.

FIG. 8 shows a plot of example correlation functions for an image of a real face onto which a light pattern is projected.

FIG. 9 shows a plot of example correlation functions for an image of a spoof face onto which a light pattern is projected.

FIG. 10 shows a plot of example correlation functions for an image of a white board material onto which a light pattern is projected.

FIG. 11 shows a flow diagram depicting an example method of determining whether a subject in an image is real or spoofed.

FIG. 12 shows a block diagram of an example computing system.

### DETAILED DESCRIPTION

As mentioned above, computing systems may utilize a camera to image a person for various purposes, such as authentication. In some examples, facial recognition may be used to authenticate a person. However, facial spoofing may be accomplished by placing an image of a person's face in front of a camera, thereby simulating their facial biometrics. Infrared imaging may make spoofing more difficult, but still may be vulnerable to spoofing.

Accordingly, examples are disclosed herein that relate to determining whether a human subject in an image is real or spoofed. Briefly, human skin is a bulk scattering medium, including in infrared and near-infrared wavelengths, as the epidermis-dermis-subcutaneous fat structure acts as a volume scatterer. The scattering effect gives rise to a somewhat “waxy” appearance of skin under infrared illumination, due to light being diffused within the skin before returning to the camera. Other materials, such as paper on which an image of a face is printed, may have different volume scattering properties than human skin. Thus, sub-surface scattering from human skin may be detected by projecting patterns of light onto a subject, imaging the subject, and analyzing in the image a contrast of the pattern as reflected by the subject. The contrast analysis may be used to discriminate between a real subject and a spoof image of the subject. Based upon determining the subject to be real, the computing device may perform an action, such as performing facial identification for authentication. Likewise, based upon determining the subject not to be real, the computing action may not perform the action. For example, the computing device may not perform facial identification upon determining the image to be of a spoof of a user's face.

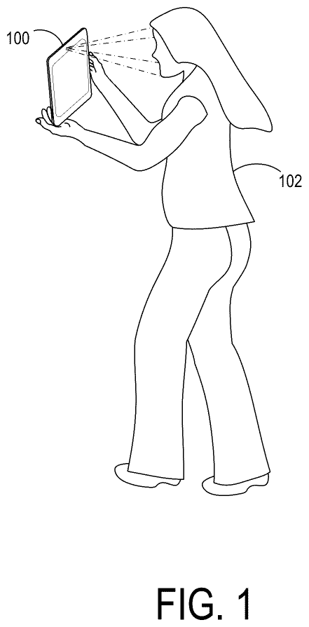

FIG. 1 shows an example use scenario in which a computing device 100 in the form of a mobile device images a subject 102, such as for authentication. Prior to performing authentication, computing device 100 first determines whether subject 102 is a real person or a spoof image (also referred to herein as “a spoof”) held in front of computing device 100. To do so, computing device 100 projects a light pattern onto subject 102 via a light pattern source of computing device 100, and captures an image of a face of subject 102 via a camera of computing device 100. Computing device 100 then analyzes a contrast of the projected light pattern as reflected by subject 102 in the image.

As mentioned above, because the human skin is a bulk scattering medium, when a light pattern is projected onto the skin, some reflected light diffuses within a volume of the skin before returning to the camera. The distance traveled by the light within the skin reduces the contrast of the light pattern in the image of the subject. Scattering lengths of human skin may be relatively long, such as approximately 0.3 mm in the dermis and 1 mm in the subcutaneous fat layer. Further, the absorption length scale of human skin is much longer (e.g. on the order of tens of millimeters), so multiple scattering events can easily occur. In contrast, for a spoof comprising an image of a face printed on paper, the average scattering length may be on the order of the paper thickness, such as approximately 0.1 mm in some examples. The longer scattering length of human skin compared to paper gives rise to differences in contrast of a light pattern reflected from these surfaces. These differences in contrast may allow a real subject to be distinguished from a spoof of the subject. Sufficiently strong differences in pattern contrast may be found even where a spoof comprises a printed image backed by a bulk diffuser material (e.g. a foam board) that attempts to mimic the volume scattering characteristics of human skin more closely.

The properties of absorption and scattering in human skin may be relatively consistent across different skin types at many wavelengths of light, including in the near-infrared. In example experiments using projected light of 633 nm, the average absorption coefficients of tested Caucasian skin were determined to be 0.033 mm⁻¹ for the dermis and 0.013 mm⁻¹ for the fat layer, while average scattering coefficients were determined to be 2.73 mm⁻¹ for the dermis and 1.26 mm⁻¹ for the fat layer. In tested Asian (Japanese specifically) and African skin, the scattering coefficients in the dermis and fat layers were similar, to the point of being not statistically significantly different. It is noted that, in the absorption spectrum of human melanin, the peak absorption occurs around 335 nm, and absorption is almost completely attenuated for wavelengths longer than 700 nm. Thus, for near infrared wavelengths of light that may be used for face imaging (e.g. 700 nm-1400 nm), a degree of melanin pigmentation may have little to no effect on reflected infrared light intensity across different skin types. In some more specific examples, light having a wavelength at or near 940 nm may be used. Light sources that emit at this wavelength are readily available, and the light is effectively invisible to the human eye.

The contrast of an imaged light pattern may be analyzed in any suitable manner. In some examples, a calculated contrast, defined as a standard deviation/mean of image pixel values, may be determined in a reflected light pattern contrast analysis. In other examples, the contrast alternatively or additionally may be analyzed as a correlation length. The term correlation length represents a distance in an image over which pixels are related in value. For example, in an image with a relatively higher-contrast pattern (e.g. a light pattern reflected by paper), an edge between a light and a dark region of the pattern is relatively sharp. As such, pixels change values from light to dark relatively abruptly in the edge region. In such an example, the correlation length may be relatively shorter, as pixels in the light region are poorly correlated with nearby pixels in the dark region. On the other hand, for an image with a relatively lower-contrast pattern (e.g. a light pattern reflected by human skin), the edge may be relatively less sharp. As such, pixels change values from light to dark more gradually in the edge region, and the correlation length may be longer. A correlation length may be computed in any suitable manner. As one example, an image patch may be defined within image data (e.g. a 30-60 pixel region of the image in some examples). The image patch may be compared to another image patch of the same size that is shifted by one pixel. As one example of such a comparison, the values for each corresponding pixel pair between the images may be multiplied, and then all products summed. This process may then be repeated using another image patch that is shifted by two pixels from the original patch, then a patch shifted by three pixels, etc. until the result of the comparison computation between the original image patch and shifted image patch drops below a threshold value. The distance between the original image patch and the final image patch in this determination may represent a correlation length. In some examples, image patches that avoid eyes, nose, mouth, and other possibly high-contrast features may be selected for pattern contrast analysis, e.g. using any suitable facial feature identification algorithm.

Continuing with FIG. 1, computing device 100 may determine, based upon the analysis of the contrast of the light pattern in the image, whether subject 102 is real or a spoof. Upon determining the face of subject 102 to be real, computing device 100 may perform an action, such as performing facial identification for an authentication process. Though described in the context of facial imaging, it will be understood that the examples disclosed herein may also be applicable to imaging of any other suitable body part of a human, such as a palm of a hand.

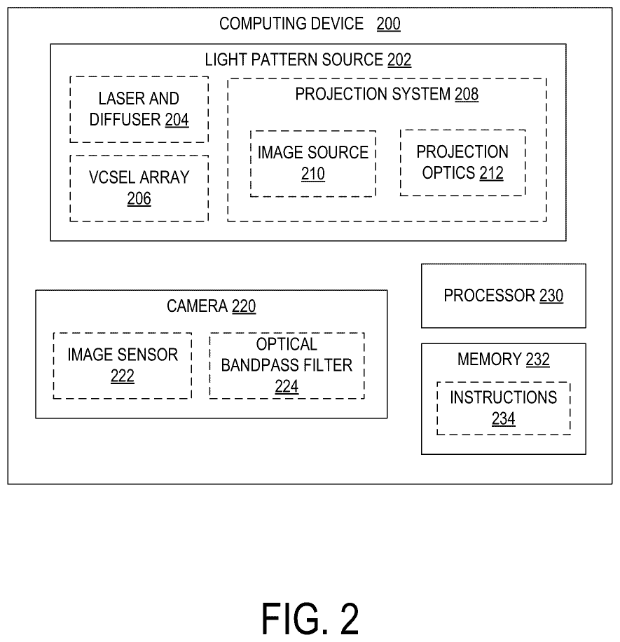

FIG. 2 shows a block diagram of an example computing device 200 configured to distinguish a real subject from a spoof by imaging the subject as illuminated by a light pattern. Computing device 100 is an example of computing device 200. Other examples of computing device 200 include smart phones, laptop computers, desktop computer, and wearable computing devices (e.g. head-mounted devices).

Computing device 200 comprises a light pattern source 202. Light pattern source 202 may take any suitable form suitable for illuminating a subject with a light pattern for imaging. In some examples, the light pattern source 202 may comprise a laser and a diffuser 204 to generate a laser speckle pattern. In some such examples, the light pattern source may comprise an array of vertical-cavity surface-emitting lasers (VCSELs) 206. Some VCSEL devices include a diffuser packaged with the laser, such as for flood illumination. Such VCSEL devices may be used with the integrated diffuser as diffuser 204 in some examples. Other VCSEL devices may omit an integrated diffuser, in which case a separate diffuser may be used as diffuser 204. In other examples, the light pattern source may comprise a projection system 208 including an image source 210 and suitable projection optics 212 to project an image produced by image source 210 toward a subject. Image source 210 may take the form of a microdisplay, such as a liquid crystal display (LCD), liquid crystal on silicon (LCoS) or organic light emitting diode (OLED) microdisplay, or may take any other suitable form. In some such examples, the light pattern projected may comprise a binary pattern, as described in more detail below. Light pattern source 202 may be configured to project the pattern using any suitable wavelength(s) of light. In some examples, the light pattern source may be configured to project infrared and/or near-infrared wavelength light.

Computing system 200 further comprises a camera 220 comprising an image sensor 222 to capture an image of a subject illuminated by the light pattern from light pattern source 202. In some examples, camera 220 may comprise an optical bandpass filter 224 configured to pass one or more wavelengths of light output by light pattern source 202 while filtering other wavelengths. This may help to reduce noise in acquired images. Camera 220 may have any suitable resolution for imaging a subject illuminated by a light pattern from light pattern source 202.

Computing system 200 further comprises a processor 230, and memory 232 comprising instructions 234 executable by processor 230 to control light pattern source 202 and camera 220, among other tasks. Instructions 234 also include instructions executable to analyze contrast in images acquired by camera 220, and to determine whether an imaged subject is real or spoofed based upon the contrast analysis performed.

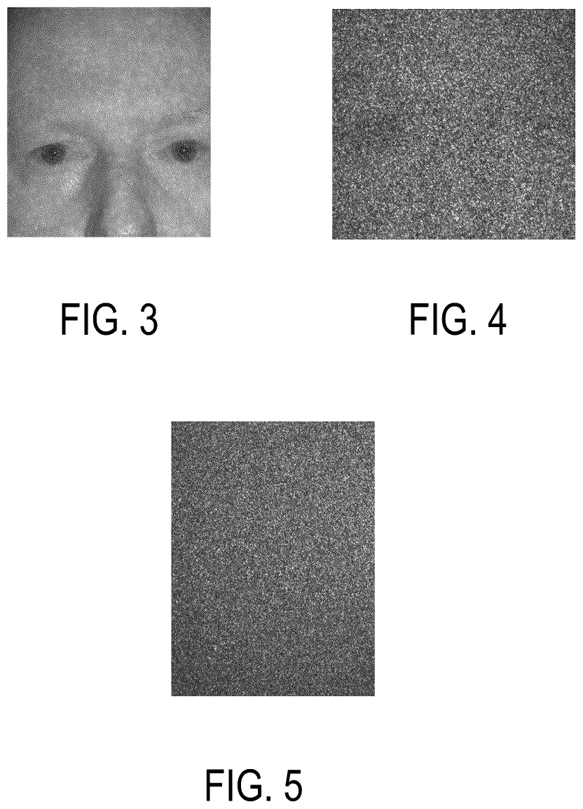

FIGS. 3-5 show example images of various subjects as illuminated by a laser speckle pattern formed via an infrared laser and an optical diffuser configured for visible light. FIG. 3 shows an image of a portion of a real face illuminated by the speckle pattern. FIG. 4 shows an image of the real face of FIG. 3 printed on a piece of paper that is illuminated by the speckle pattern. FIG. 5 shows an image of a piece of white board material illuminated by the speckle pattern. The term “white board” as used in the experiment descriptions here refers to a white film layer backed by aluminum. Here, the appearance of the real face in the image of FIG. 3 is visibly distinct from the other images. It will be appreciated that the use of an optical diffuser configured for infrared light will provide for a higher contrast infrared laser speckle pattern than a diffuser configured for visible light.

Table 1 shows experimental analyses of speckle contrast and correlation length that were performed for the captured images. Contrast in each image was analyzed as a calculated contrast (standard deviation divided by the mean of pixel values) and correlation length determined using a forty pixel-sized image patch. Each computation was performed for a plurality of patches in each image, and the results from the patches tested were averaged.

TABLE 1
Speckle contrast results for real face versus other materials

| | Real face | Spoof face | White board |
|---|---|---|---|
| Calculated contrast | 0.12 | 0.61 | 0.55 |
| Correlation length (mm) | 0.60 | 0.33 | 0.36 |

The differences in speckle contrast between the real face image and the other images in Table 1 are on the order of 1:5. This indicates that the light pattern in the image of the real face has a lower contrast compared to the other imaged subjects. Further, the differences in correlation length between the real face image and the other images are on the order of 2:1. This indicates the greater scattering length of human skin compared to the other subjects. As such, the determination of a calculated contrast and/or correlation length may provide a relatively strong indication regarding whether an imaged subject is a real human or a spoof.

In some examples, threshold values may be determined based upon such experimental data for use in distinguishing between a real subject and a spoof. For example, if a calculated contrast meets (e.g. is equal to or below) a threshold calculated contrast, and/or the correlation length meets (e.g. is equal to or above) a threshold correlation length, the subject may be determined to be a real subject. Conversely, if the result(s) of the contrast analysis fails to meet either or both thresholds, the subject may be determined to be a spoof.

In another experiment, a single-mode 780 nm fiber-coupled laser with an output of 100 mW and a 15° visible light diffuser were used to generate a high-contrast speckle pattern. As the diffuser was configured for visible light, higher contrast than achieved in the experiment may be realized by using a diffuser designed for infrared light. The separation between the fiber output and the diffuser was varied to change the size of the speckle pattern. Images of a real face and a white board (which, in this experiment, comprised an approximately 100 μm thick white film on aluminum) were captured for each speckle pattern size using a machine vision camera. The speckle contrast and correlation length of the resulting imaged speckle patterns were measured by segmenting each image into patches of forty pixels, removing smooth variations over each patch, and then autocorrelating each of the patches using the process described above in paragraph [0023].

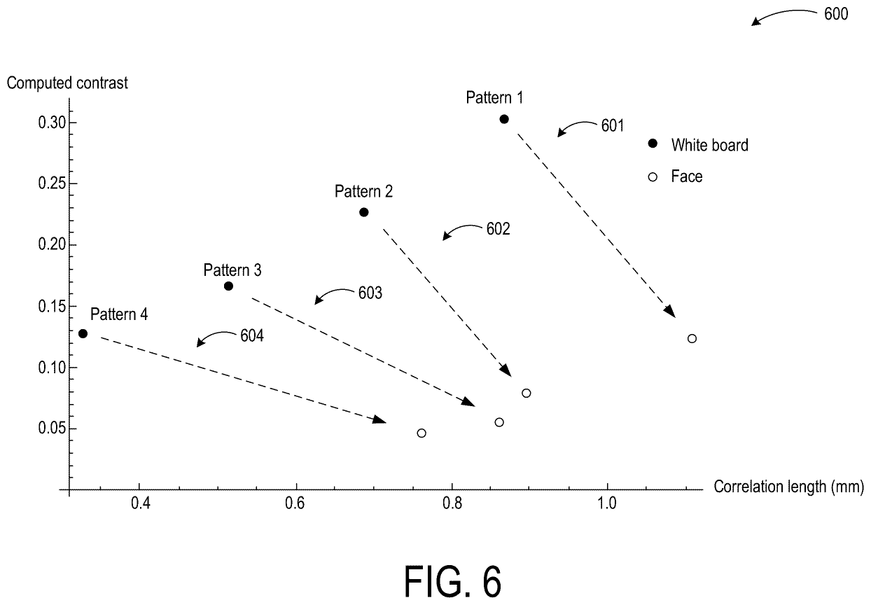

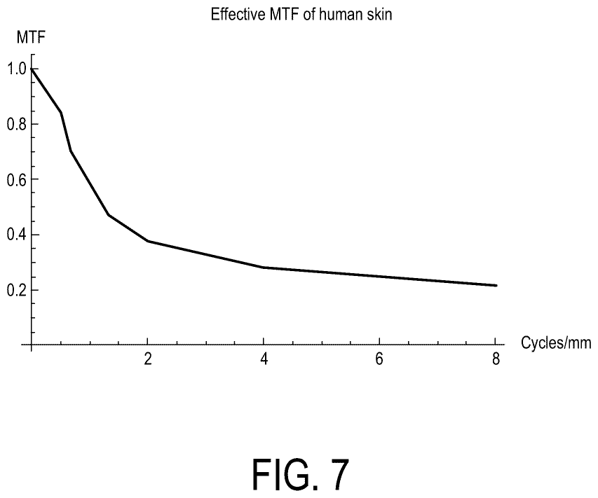

FIG. 7 shows a plot 600 of calculated contrast versus correlation length (mm) for the white board material and the real face illuminated by four different speckle pattern sizes. Pattern 1 is shown at 601, Pattern 2 at 602, Pattern 3 at 603, and Pattern 4 at 604. The patterns increased in spatial frequency (cycles/mm) from Pattern 1 through Pattern 4. For the real face, the calculated contrast for all speckle patterns is lower and the correlation length is longer compared to that of the white board. This further indicates that lower speckle contrast and/or higher correlation length may be an indicator for determining that a subject is real as opposed to a spoof, even across patterns of varying spatial frequency. It is noted that the values plotted in this figure should be considered qualitative rather than strictly quantitative due to a correction in image gamma not made to the data. It can be seen in FIG. 6 that the finer the projected pattern (i.e. the higher spatial frequency) of the pattern projected onto the skin, the less of a difference there is between the speckle contrast of the real face and the speckle contrast of the white board. Conversely, the difference in correlation length increases with increasing spatial frequency.

A light pattern source may be configured to output a light pattern having any suitable angular frequency to form a light pattern of a desired spatial frequency on a subject. In some examples, a light pattern source may be configured to illuminate a subject at a distance of 400-750 mm from the light pattern source with a light pattern comprising a spatial frequency within a range of 0.1 to 8 cycles/millimeter.

In another example experiment, using an optical model of the human skin, an effective skin modulation transfer function (MTF) was plotted by projecting sinusoidal patterns at varying spatial frequencies, and measuring the contrast of the resulting sinusoid from light exiting the surface of the skin. The optical model included multiple layers of Henyey-Greenstein volume scatterers with varying parameters configured for visible wavelengths. FIG. 7 shows a plot of effective skin MTF versus spatial frequency as determined in this experiment. Here, an increase in light pattern spatial frequency leads to the effective skin MTF leveling off as the spatial frequency approaches 8 cycles/mm. Thus, as mentioned above, in some examples, a light pattern source may be configured to project a light pattern having a spatial frequency within a range of 0.1 to 8 cycles/mm onto a subject located a suitable distance from the light pattern source, such as between 400-750 mm from the light pattern source. In other examples, a light pattern source may be configured to form a light pattern having any other suitable spatial frequency and/or at any other suitable distance from the light pattern source.

In some examples, instead of a pattern with cycles of dark/bright regions, a pattern with a single edge between a dark and a bright region may be used to illuminate a subject. In such examples, the projector outputs a sharp edge, which is “softened” different degrees in a reflected image depending upon a medium from which it reflects (e.g. skin, paper or other). Image data of the softened edge may be differentiated to produce a line spread function. A Fourier transform may then be applied to the line spread function. The effective MTF then may be determined from the results of the Fourier transform (e.g. using ISO 12233, which describes a standard slanted edge MTF measurement), and used as a contrast analysis to distinguish between a real subject and a spoof.

Although laser speckle patterns were used in the experiments described above using a VCSEL laser array and diffuser, it will be understood that any other suitable image pattern source and any other suitable spatial pattern may be utilized. As another example, a single-mode laser and diffuser may be used. Such a system is of low complexity, but may also involve the use of a separate LED to obtain a DC signal for biometric analysis and authentication, unless the laser can be decohered. As further example, instead of diffusing light from the VCSEL, the spots produced by a VCSEL array may be projected, and a point spread function measurement may be performed to estimate local scattering properties. In such an example a lens with a relatively short focal length (e.g. 2 mm) and an at least partially telecentric object space may be used to capture the VCSEL emission. As yet another examples, a narrow-angle diffuser or diffractive optic may be used with a VCSEL array to create an array of local high-contrast patterns around each VCSEL spot. As an additional example, a VCSEL array with a relatively lesser number of lasers may increase speckle contrast relative to the use of a VCSEL array with a relatively greater number lasers.

Further, as mentioned above, a projector may be used to generate an image pattern with known statistics. In some examples, the pattern may comprise a binary pattern in which values are either dark or light, as opposed to a continuous function (such as a speckle pattern) in which the pattern varies continuously between dark and light. Example binary patterns include a Hadamard code (e.g. a Walsh function or a pseudo-random binary function). The pattern thus projected may be used both to measure MTF (e.g. using a slanted-edge method on edges of the code pattern), and to check that a correct code was projected. These processes may help to prevent spoofing by pre-printing patterns

As mentioned above, a determination regarding whether an imaged subject is real or a spoof may be used to control another computing device function, such as authentication. In some examples, a different imaging system may be used to image a subject for authentication. Such an imaging system may comprise a projector that is configured to project light of a relatively level intensity across an imaged field, as opposed to a light pattern. This may facilitate a biometric analysis for authentication. In other examples, a same image system may be used for spoof detection and authentication. In such an example, a light pattern source may be controllable to effectively turn the pattern “on” or “off” In the instance of an image projector, different images may be projected for spoof detection and authentication. In the instance of a speckle pattern generated by a laser light source and diffuser, a spectral bandwidth of the laser light source may be modulated to increase a wavelength range output by the laser and thereby reduce speckle contrast.

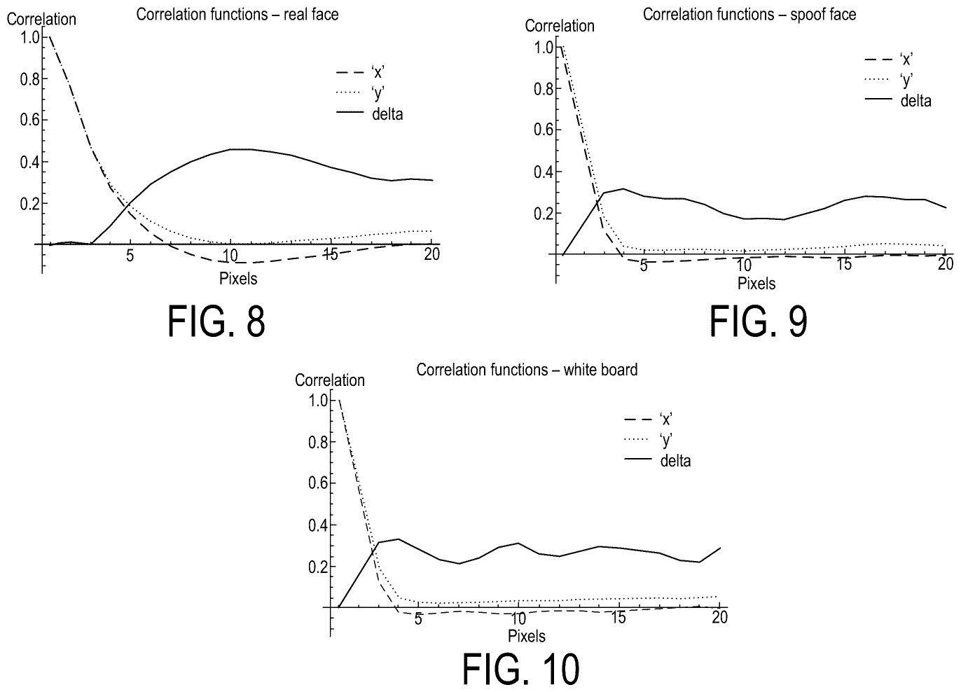

FIGS. 8-10 respectively show plots of example correlation functions for a real face, a spoof face, and a white board material. Each plot shows a computed normalized correlation for two image patches as a function of a pixel distance separating the two patches. The labels “x” and “y” indicate arbitrary orthogonal directions on the subject surface. These figures also show a “delta” plot, which is a mean of the absolute difference of the x and y correlation values at a magnification of 5× (for ease of viewing). If scattering lengths were isotropic, then there would be no difference on average between the correlation functions along orthogonal axes, such that the delta line would lie along the x-axis. Here, each graph shows a non-zero delta plot. This suggests that either the statistics of the diffuser are not isotropic, and/or that the illumination patch is not circular, in this experiment. However, FIGS. 8-10 do show a pronounced difference between the curves for the real face and the curves for the other materials. This may indicate that the human face has more anisotropic scattering lengths as a function of direction than other materials. Without wishing to be bound by theory, this may be due to the orientation of collagen fibers in the human skin. Thus, a degree of anisotropy between scattering lengths in orthogonal directions may be a further indicator of whether an imaged subject is real or a spoof.

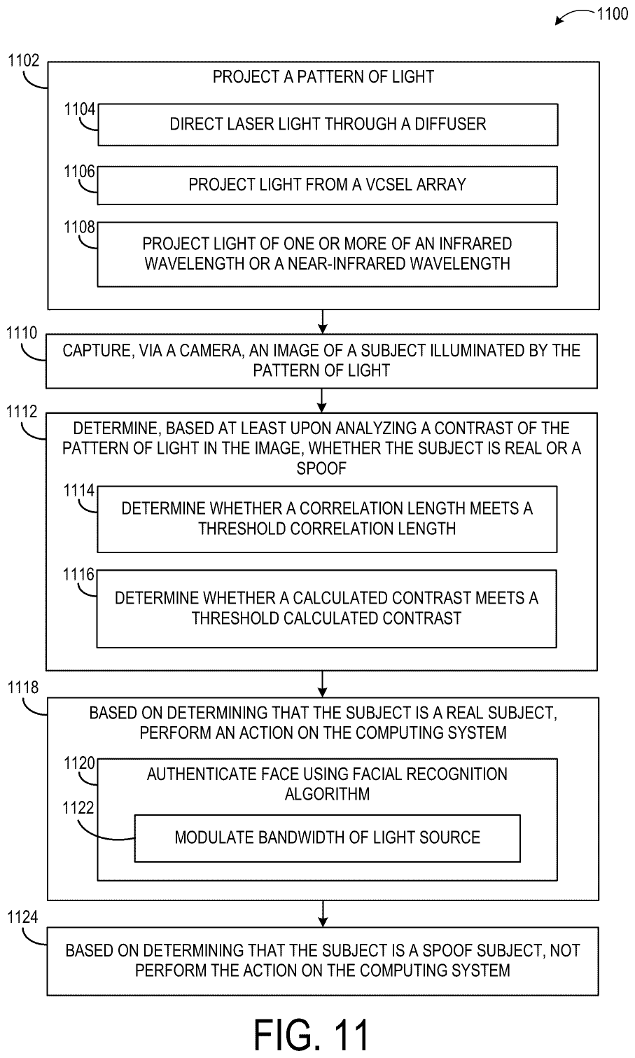

FIG. 11 shows an example method 1100 of determining whether a subject is real or a spoof. Method 1100 may be enacted on any suitable computing system. Method 1100 includes, at 1102, projecting a light pattern. In some examples, projecting a light pattern may include, at 1104, directing a laser light through a diffuser to form a speckle pattern. In other examples, projecting a light pattern may include, at 1106, emitting light from a VCSEL array to form a speckle pattern. In yet other examples, an image projector may be used to project a predetermined image of a pattern. In some examples, the image projector may be configured to project a binary pattern. In other examples, any other suitable light pattern source may be used to project the light pattern. In some examples, the projected light may comprise infrared and/or near-infrared wavelengths, as shown at 1108.

Method 1100 further includes, at 1110, capturing, via a camera, an image of a subject illuminated by the light pattern. In some examples, the image may be analyzed to identify the presence of a subject, e.g. via by a facial detection algorithm. Similar methods may be used to detect a palm or other body part in other examples.

Where it is determined that a subject is present, it may be determined, based at least upon analyzing a contrast of the light pattern in the image, whether the subject is real or a spoof, as shown at 1112. First, one or more image patches may be selected for analysis in the image. Examples include patches that avoid eyes, nose, mouth, and other possibly high-contrast features. Next, a measure of the contrast of the pattern in the image patch(es) may be determined. For example, a correlation length and/or a calculated contrast may be determined for each image patch. Where a plurality of image patches are used for analysis, the results of the contrast analysis for the patches may be averaged or otherwise computationally combined. Continuing, in some examples, determining whether a subject is real may include, at 1114, determining whether a pattern correlation length meets a threshold condition (e.g. is equal to or exceeds a threshold correlation length). Alternatively or additionally, in some examples, determining whether a subject is real may include, at 1116, determining whether a calculated contrast meets a threshold condition (e.g. is equal to or less than a threshold contrast). In some examples, a combination of both 1114 and 1116 may be used to determine whether the subject is real.

At 1118, based on determining that the subject is real, the computing system performs an action. For instance, at 1120, the computing system may perform facial recognition to authenticate an imaged face. Facial authentication may be used for various applications, such as for user-restricted access (e.g. to the device, to file content, to perform administrative processes) and/or for authorizing transactions. In some examples, a bandwidth of the light source used to project the light pattern may be modulated, at 1122, to reduce a contrast of the pattern for performing facial authentication using a same light source as used for light pattern projection. In other examples, a different imaging system may be used for facial authentication. Further, in other examples, a different body part, such as a palm, may be used for authentication.

In contrast, where it is determined that the subject is a spoof, method 1100 includes, at 1124, not performing the action the computing system. In some such examples, the computing system may output a notification indicating that the subject is detected as a spoof, perform a lockdown of system functions, and/or otherwise perform security measures in response to determining that a spoof is being attempted.

In some embodiments, the methods and processes described herein may be tied to a computing system of one or more computing devices. In particular, such methods and processes may be implemented as a computer-application program or service, an application-programming interface (API), a library, and/or other computer-program product.

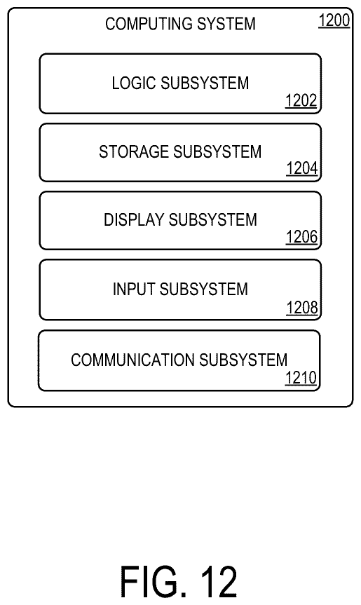

FIG. 12 schematically shows a non-limiting embodiment of a computing system 1200 that can enact one or more of the methods and processes described above. Computing system 1200 is shown in simplified form. Computing system 1200 may take the form of one or more personal computers, server computers, tablet computers, home-entertainment computers, network computing devices, gaming devices, mobile computing devices, mobile communication devices (e.g., smart phone), computing device 100, computing device 200, and/or other computing devices.

Computing system 1200 includes a logic subsystem 1202 and a storage subsystem 1204. Computing system 1200 may optionally include a display subsystem 1206, input subsystem 1208, communication subsystem 1210, and/or other components not shown in FIG. 12.

Logic subsystem 1202 includes one or more physical devices configured to execute instructions. For example, logic subsystem 1202 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 1202 may include one or more processors configured to execute software instructions. Additionally or alternatively, logic subsystem 1202 may include one or more hardware or firmware logic machines configured to execute hardware or firmware instructions. Processors of logic subsystem 1202 may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of logic subsystem 1202 may be virtualized and executed by remotely accessible, networked computing devices configured in a cloud-computing configuration.

Storage subsystem 1204 includes one or more physical devices configured to hold instructions executable by logic subsystem 1202 to implement the methods and processes described herein. When such methods and processes are implemented, the state of storage subsystem 1204 may be transformed—e.g., to hold different data.

Storage subsystem 1204 may include removable and/or built-in devices. Storage subsystem 1204 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1204 may include volatile, nonvolatile, dynamic, static, read/write, read-only, random-access, sequential-access, location-addressable, file-addressable, and/or content-addressable devices.

It will be appreciated that storage subsystem 1204 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1202 and storage subsystem 1204 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1206 may be used to present a visual representation of data held by storage subsystem 1204. This visual representation may take the form of a graphical user interface (GUI). As the herein described methods and processes change the data held by the storage machine, and thus transform the state of the storage machine, the state of display subsystem 1206 may likewise be transformed to visually represent changes in the underlying data. Display subsystem 1206 may include one or more display devices utilizing virtually any type of technology. Such display devices may be combined with logic subsystem 1202 and/or storage subsystem 1204 in a shared enclosure, or such display devices may be peripheral display devices.

When included, input subsystem 1208 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1210 may be configured to communicatively couple computing system 1200 with one or more other computing devices. Communication subsystem 1210 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the Internet.

Another example provides a computing system, comprising a camera, a light pattern source configured to output a light pattern, a logic subsystem, and a storage subsystem storing instructions executable by the logic subsystem to capture, via the camera, an image of a subject illuminated by the light pattern emitted by the light pattern source, analyze a contrast of the light pattern in the image of the subject, determine, based at least upon analyzing the contrast of the light pattern in the image, whether the subject is real or a spoof, based at least upon determining that the subject is real, perform an action on the computing system, and based at least up on determining that the subject is a spoof, not perform the action on the computing system. In some such examples, the light pattern source comprises a laser and a diffuser. In some such examples, the laser comprises an array of vertical-cavity surface-emitting lasers (VCSELs). In some such examples, the light pattern alternatively or additionally comprises a binary light pattern. In some such examples, the instructions executable to determine, based at least upon analyzing the contrast of the light pattern in the image, whether the subject is real or a spoof alternatively or additionally comprise instructions executable to determine whether a correlation length meets a threshold correlation length. In some such examples, the instructions executable to determine, based at least upon analyzing the contrast of the light pattern in the image, whether the subject is the real subject or the spoof subject alternatively or additionally comprise instructions executable to determine whether a calculated contrast meets a threshold calculated contrast. In some such examples, the light pattern source alternatively or additionally is configured to illuminate a subject at a distance of 400-750 mm with a light pattern comprising a spatial frequency within a range of 0.1 to 8 cycles/millimeter. In some such examples, the instructions alternatively or additionally are executable to modulate a bandwidth of the light pattern source.

Another example provides, on a computing system, a method comprising projecting a light pattern, capturing, via a camera, an image of a subject illuminated by the light pattern, analyzing a contrast of the light pattern in the image of the subject, determining, based at least upon analyzing the contrast of the light pattern in the image, whether the subject is real or a spoof, based at least upon determining that the subject is real, perform an action on the computing system, and based at least up on determining that the subject is a spoof, not perform the action on the computing system. In some such examples, projecting the light pattern comprises directing laser light through a diffuser to form a speckle pattern. In some such examples, projecting the light pattern comprises projecting light from an array of vertical-cavity surface-emitting laser (VCSELs). In some such examples, projecting the light pattern comprises projecting a binary light pattern. In some such examples, determining, based at least upon the contrast of the light pattern in the image, whether the subject is real or a spoof alternatively or additionally comprises determining whether a pattern correlation length meets a threshold correlation length. In some such examples, determining, based at least upon analyzing contrast of the light pattern in the image, whether the subject is the real subject or the spoof subject alternatively or additionally comprises determining whether a calculated contrast meets a threshold contrast.

Another example provides a computing system comprising a camera, a light pattern source configured to output a light pattern, a logic subsystem, and a storage subsystem storing instructions executable by the logic subsystem to capture, via the camera, an image of a face illuminated by the light pattern output by the light pattern source, determine, based at least upon a contrast of the light pattern in the image, whether the face is real or a spoof, and based upon determining that the face is real, authenticate the face using a facial recognition algorithm. In some such examples, the light pattern source comprises a laser and a diffuser. In some such examples, the laser comprises an array of vertical-cavity surface-emitting lasers (VCSELs). In some such examples, the light pattern source alternatively or additionally is configured to emit light of one or more of an infrared wavelength or a near-infrared wavelength. In some such examples, the instructions executable to determine, based at least upon the contrast of the light pattern in the image, whether the subject is the real subject or the spoof subject alternatively or additionally comprise instructions executable to determine whether a correlation length meets or exceeds a threshold correlation length. In some such examples, the instructions executable to determine, based at least upon the contrast of the light pattern in the image, whether the subject is the real subject or the spoof subject alternatively or additionally comprise instructions executable to determine a whether a calculated contrast meets or is lesser than a threshold calculated contrast.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a camera;
a light pattern source configured to output a light pattern;
a logic subsystem; and
a storage subsystem storing instructions executable by the logic subsystem to
capture, via the camera, an image of a subject illuminated by the light pattern emitted by the light pattern source,
analyze a contrast of the light pattern in the image of the subject,
determine, based at least upon analyzing the contrast of the light pattern in the image, whether the subject is real or a spoof,
based at least upon determining that the subject is real, perform an action on the computing system; and
based at least up on determining that the subject is a spoof, not perform the action on the computing system.

2. The computing system of claim 1, wherein the light pattern source comprises a laser and a diffuser.

3. The computing system of claim 2, wherein the laser comprises an array of vertical-cavity surface-emitting lasers (VC SELs).

4. The computing system of claim 1, wherein the light pattern comprises a binary light pattern.

5. The computing system of claim 1, wherein the instructions executable to determine, based at least upon analyzing the contrast of the light pattern in the image, whether the subject is real or a spoof comprise instructions executable to determine whether a correlation length meets a threshold correlation length.

6. The computing system of claim 1, wherein the instructions executable to determine, based at least upon analyzing the contrast of the light pattern in the image, whether the subject is the real subject or the spoof subject comprise instructions executable to determine whether a calculated contrast meets a threshold calculated contrast.

7. The computing system of claim 1, wherein the light pattern source is configured to illuminate a subject at a distance of 400-750 mm with a light pattern comprising a spatial frequency within a range of 0.1 to 8 cycles/millimeter.

8. The computing system of claim 1, wherein the instructions are executable to modulate a bandwidth of the light pattern source.

9. On a computing system, a method comprising:
projecting a light pattern;
capturing, via a camera, an image of a subject illuminated by the light pattern;
analyzing a contrast of the light pattern in the image of the subject;
determining, based at least upon analyzing the contrast of the light pattern in the image, whether the subject is real or a spoof;
based at least upon determining that the subject is real, perform an action on the computing system; and
based at least up on determining that the subject is a spoof, not perform the action on the computing system.

10. The method of claim 9, wherein projecting the light pattern comprises directing laser light through a diffuser to form a speckle pattern.

11. The method of claim 10, wherein projecting the light pattern comprises projecting light from an array of vertical-cavity surface-emitting laser (VCSELs).

12. The method of claim 9, wherein projecting the light pattern comprises projecting a binary light pattern.

13. The method of claim 9, wherein determining, based at least upon the contrast of the light pattern in the image, whether the subject is real or a spoof comprises determining whether a pattern correlation length meets a threshold correlation length.

14. The method of claim 9, wherein determining, based at least upon analyzing contrast of the light pattern in the image, whether the subject is the real subject or the spoof subject comprises determining whether a calculated contrast meets a threshold contrast.

15. A computing system, comprising:
a camera;
a light pattern source configured to output a light pattern;
a logic subsystem; and
a storage subsystem storing instructions executable by the logic subsystem to
capture, via the camera, an image of a face illuminated by the light pattern output by the light pattern source,
determine, based at least upon a contrast of the light pattern in the image, whether the face is real or a spoof, and
based upon determining that the face is real, authenticate the face using a facial recognition algorithm.

16. The computing system of claim 15, wherein the light pattern source comprises a laser and a diffuser.

17. The computing system of claim 16, wherein the laser comprises an array of vertical-cavity surface-emitting lasers (VC SELs).

18. The computing system of claim 15, wherein the light pattern source is configured to emit light of one or more of an infrared wavelength or a near-infrared wavelength.

19. The computing system of claim 15, wherein the instructions executable to determine, based at least upon the contrast of the light pattern in the image, whether the subject is the real subject or the spoof subject comprise instructions executable to determine whether a correlation length meets or exceeds a threshold correlation length.

20. The computing system of claim 15, wherein the instructions executable to determine, based at least upon the contrast of the light pattern in the image, whether the subject is the real subject or the spoof subject comprise instructions executable to determine a whether a calculated contrast meets or is lesser than a threshold calculated contrast.
